(19) United States
(12) Patent Application Publication
(10) Pub. No.: US 2002/0193029 A1
(43) Pub. Date: Dec. 19, 2002

(54) Wiping cloth made of nonwoven fabric and process for producing the same

(76) Inventors: Yukihiro Kihara, Okazaki-shi (JP); Hirotaka Takagi, Okazaki-shi (JP)

Correspondence Address: Felix J D'Ambrosio, Jones Tullar & Cooper, PO Box 2266 Eads Station, Arlington, VA, 22202, US

(21) Appl. No.: 09/869,337

(22) PCT Filed: Nov. 30, 2000
(86) PCT No.: PCT/JP00/08490

(30) Foreign Application Priority Data
Nov. 30, 1999 (JP) 11-340209
Mar. 24, 2000 (JP) 2000-84200

(51) Int. Cl. B32B 3/00

(52) U.S. Cl. 442/361; 442/59

(57) ABSTRACT

A wiping cloth made of nonwoven fabric of which water-absorbing property is superior and deteriorates less with age is provided. This wiping cloth made of nonwoven fabric is obtained using specific splittable conjugate fibers. The splittable conjugate fibers are formed by sticking a polyester polymer component A containing polyoxyalkyleneglycol of 2000 to 20000 in mass average molecular weight and a polyolefin polymer component B not compatible with said polymer component A together. Fibers A composed of the polymer component A and fibers B composed of the polymer component B are formed by exfoliating the sticking of the splittable conjugate fibers. Plasma treatment is applied to exfoliated faces of the fibers A and the fibers B. The water-absorbing property is largely improved due to synergism of polyoxyalkyleneglycol and plasma treatment applied to the exfoliated faces of the fibers A and B.

### TECHNICAL FIELD

The present invention relates to a wiping cloth superior in removing dust and absorbing water and to a method for manufacturing the wiping cloth. In particular, the invention relates to a wiping cloth superior in removing fine dust and in absorbing water and suitable for use in clean room and to a method for manufacturing such wiping cloth.

### BACKGROUND ART

A wiping cloth made of nonwoven fabric consisting of cellulose filaments, for example, has been heretofore known as a wiping cloth to be used in clean room. Such a wiping cloth is advantageous because of its superiority in water absorption due to hydrophobic property of cellulose filaments. However, if the cellulose filaments are decreased in fineness (for example, 1 denier or less) in order to improve the property of removing fine dust (removability), the cloth is prone to generate cellulose powder, which is not favorable as a wiping cloth to be used in clean room. It is considered that the cellulose powder is generated because filament breakage occurs due to decrease in tensile strength when the fineness of the cellulose filaments is small. The foregoing powder (fibrous powder) produced from the fibers due to filament breakage is generally called lint.

A wiping cloth made of nonwoven fabric or woven or knitted fabric consisting of synthetic fibers such as polyester fibers has been also known. Such synthetic fibers maintain a certain tensile strength and produce a less lint even if the denier is small as compared with the cellulose fibers. In this sense, the synthetic fibers are suitable for a wiping cloth to be used in clean room as compared with the use of the cellulose fibers. However, in the synthetic fibers, there is a disadvantage that the synthetic fibers are poor in hydrophlic property as compared with the cellulose fibers (in other words, the synthetic fibers are hydrophobic) and therefore it is impossible to give a sufficient water-absorbing characteristic to the wiping cloth.

For this reason, a wiping cloth provided with micropores on the surface of polyester fibers of not more than 1.5 deniers in single fiber fineness was proposed (the Japanese Patent Publication (unexamined) No. 89642/1983). However, There arises a disadvantage in that forming the micropores on the surfaces of the polyester fibers of fine fibers causes deterioration in tensile strength of the polyester fibers themselves and production of lint. Another wiping cloth produced by coating the surface of the fibers with a substance having hydrophlic property or water-absorbing property was also proposed (Japanese Patent Publication (unexamined) No. 4297/1982). However, in the case of this wiping cloth, denier of the fibers becomes large and there is a possibility that the performance of removing fine dust is decreased.

A further wiping cloth in which water-absorbing property is improved by applying a plasma treatment to a melt blow nonwoven fabric consisting of polyethylene terepnthaiate fibers of not more than 0.8 denier in average fineness was also proposed (the Japanese Patent Publication (unexamined) No. 33270/1989). However, in the melt blow method, extra fine fibers are obtained by blowing a melt polymer emerged from a spinning hole with gas, and therefore, molecular orientation in the obtained extra fine fibers is insufficient as compared with fibers obtained through drawing. As a result, it is difficult to obtain fibers having a sufficient tensile strength. Consequently, there arises a problem that the melt blow nonwoven fabric put into use to serve as a wiping cloth is prone to produce lint.

In view of the foregoing problems of the prior arts, the applicants of the present invention have proposed a wiping cloth made of nonwoven fabric produced by combining splitting of splittable conjugate fibers with plasma treatment as a wiping cloth superior in removing fine dust and absorbing water and hardly produces lint (the Japanese Patent Publication (unexamined) No. 140471/1998). This known wiping cloth made of nonwoven fabric is produced by using splittable conjugate fibers each of which is formed by sticking a polymer component A and a polymer component B which is insoluble in the polymer component A, accumulating fibers A composed of the polymer component A and fibers B composed of the polymer component B formed by exfoliating the stuck splittable conjugate fibers, and modifying exfoliated faces of the fibers A and the fibers B through plasma treatment In other words this wiping cloth made of nonwoven fabric is intended to improve the water-absorbing property by utilizing unevenness or microfibers existing on the exfoliated faces of the split fibers, improve the property of removing fine dust utilizing the fibers A and B of relatively small denier composed of the polymer components A and B and decrease production of lint.

The present invention utilizes the invention disclosed in the foregoing Japanese Patent Publication (unexamined) No. 140471/1998. and has an object of providing a wiping cloth made of nonwoven fabric in which the water-absorbing property is further hardly deteriorated with age(the passage of time) by adopting a component containing a specific substance as the polymer component A.

### DISCLOSURE OF INVENTION

The present invention provides a wiping cloth made of nonwoven fabric produced by using splittable conjugate fibers each of which is formed by sticking a polyester polymer component A containing polyoxyalkyleneglycol of 2000 to 20000 in mass average molecular weight and a polyolefin polymer component B which is insoluble in the polymer component A, accumulating fibers A composed of the polymer component A and fibers B composed of the polymer component B formed by exfoliating the sticking of the splittable conjugate fibers, and modifying exfoliated faces of the fibers A and the fibers B through plasma treatment. The invention also provides a method for manufacturing the wiping cloth made of nonwoven fabric

The splittable conjugate fiber used in this invention is formed by sticking the polyester polymer component A containing polyoxyalkyleneglycol of 2000 to 20000 in mass average molecular weight and the polyolefin polymer component B which is insoluble in the polymer component A. Specific examples of the sticking manner are shown in FIGS. 1 to 4, and the sticking manner is not limited to those examples. Each of FIGS. 1 to 4 is a transverse cross section of a splittable conjugate fiber. FIG. 1 shows a splittable conjugate fiber in which a plurality of polymer components A are embedded in an outer circumferential portion of the polymer component B, and the polymer components A and the polymer component B are stuck together. FIG. 2 shows a splittable conjugate fiber in which there are a plurality of polymer components A and a plurality of polymer components B each forming a trapezoid in transverse section, and lateral sides of the trapezoids are respectively stuck together to form the splittable conjugate fiber being circular as a whole in transverse section. A blank portion in FIG. 2 indicates a hollow part, and therefore the splittable conjugate fiber FIG. 2 is hollow and cylindrical. FIG. 3 shows a splittable conjugate fiber in which there is a plurality of polymer components A and a plurality of polymer components B each being wedge-shaped in transverse section, and lateral sides of the wedges are respectively stuck together to form a splittable conjugate fiber being circular as a whole in transverse section. FIG. 4 shows a splittable conjugate fiber in which a plurality of polymer components A (each of the polymer components A being circular in transverse section) is stuck to an outer circumferential portion of a polymer component B.

The polyester polymer component A containing polyoxyalkyleneglycol of 2000 to 20000 in mass average molecular weight and the polyolefin polymer component B are insoluble in each other In other words, the polymer component B is insoluble in the polymer component A As a result the polymer component A and the polymer component Bare easily exfoliated from each other at the sticking portion of the polymer components A and B. If the polymer component A and the polymer component B are soluble in each other, the polymer components A and B will be mingled in each other and hardly exfoliated at the sticking portion of the polymer components A and B. The splittable conjugate fiber is generally composed of the polymer component A and the polymer component B, however, it is also preferred that a further polymer component exists as a third component.

The polyester polymer component A is produced by adding polyoxyalkyleneglycol of 2000 to 20000 in mass average molecular weight to a polyester polymer. If a mere polyester polymer without any such addition of polyoxyalkyleneglycol is used, there is a tendency that the water-absorbing property is not sufficiently given to the wiping cloth made of nonwoven fabric. Specific amount of content is preferably in the range of 1.5 to 15 mass percent of the polyester polymer and more preferably in the range of 3 to 10 masses percent. If the content is less than 1.5 mass percent, the water-absorbing property of the wiping cloth made of nonwoven fabric is prone to decrease with time. On the other hand, if the content is more than 15 mass percent, the fibers A formed of the polyester polymer component A are prone to be lowered in strength. It is possible to adopt polyethylene terephthalate, polyethylene terephthalate, or copolymer polyester of which main component is polyethylene terephthalate or polyethylene terephthalate as the polyester polymer.

The mass average molecular weight of polyoxyalkyleneglycol to be added is in the range of 2000 to 20000, and preferably in the range of 3000 to 10000 It is not desired that the mass average molecular weight is less than 2000 because it is not possible to obtain the polyester polymer component A of which spinning efficiency is superior. More specifically, polyoxyalkyleneglycol is generally added at the stage of manufacturing the polyester polymer by condensing acid and alcohol (especially at the latter half of the stage of the polymerization). In the case that the molecular weight of polyoxyalkyleneglycol is less than 2000. polyoxyalkyleneglycol easily reacts on acid and alcohol, and consequently, it is difficult to obtain the polyester polymer of a high molecular weight, and the spinning efficiency becomes unstable. On the other hand, if the mass average molecular weight is more than 20000, the cloth is not desirable because water-absorbing property is not sufficiently given to the cloth to serve as a wiping cloth.

Melting point of the polyester polymer component A is preferably in the range of about 160 to 275° C., and more preferably in the range of about 180 to 260° C. If the melting point of the polymer component A is more than 275° C., there is a possibility of occurring heat decomposition of the polyester polymer and the polyoxyalkyleneglycol at the time of melt spinning. On the other hand, if the melting point is less than 160° C., there is a possibility of lowering in operation efficiency at the time of melt spinning. The melting point of the polyolefin polymer component B is preferred to be lower than the melting point of the polymer component A, more preferably, lower than the melting point by at least 30° C., and most preferably lower than the melting point by at least 50° C. This is because when heating the splittable conjugate fibers thereby forming heat-bonded areas in which the splittable conjugate fibers are heat bonded one another, it is possible to soften or melt only the polymer component B while keeping the fiber form of the polymer component A as it is without softening and melting it. Therefore, the fibers composed of the polymer component A are left even in the heat-bonded areas, and it is possible to obtain a strong wiping cloth made of nonwoven fabric. For example, if the melting point of the polymer component A and the melting point of the polymer component B are almost the same, the whole heat-bonded areas are melt or softened and turned into a film-like condition. As a result, strength is lowered in the heat-bonded areas, and it is difficult to obtain a strong wiping cloth made of nonwoven fabric. If there is a large difference between the melting point of the polymer component A and that of the polymer component B (for example, a difference between theme points mounts to 180° C. or more), it becomes difficult to manufacture splittable conjugate fibers through melt spinning method. It is preferred that polypropylene, high-density polyethylene, linear low-density polyethylene-ethylene-propylene copolymer or the like are adopted as the polyolefin polymer component B.

In this invention, each of the melting points of the polyester polymer component A and the polyolefin polymer component B is established to be a temperature showing an extreme value of a melting endothermic curve obtained by raising the temperature from the room temperature at a speed of 20° C./min using a differential calorimeter (DSC-2C manufactured by Perkin Elmer).

As described above, adding polyoxyalkyleneglycol to the polyester polymer produces the polyester polymer component A. It is also preferred that various kinds of additives such as lubricant, pigment, delustering agent, heat stabilizer, light resistance agent, ultraviolet absorber, antistatic agent, conductive agent, and thermal storage agent are added and contained, if necessary. It is also preferred that the polyolefin polymer also contains the mentioned various kinds of additives.

It is possible to freely decide quantitative proportion of the polymer components A and B in the splittable conjugate fiber. It is, however, more preferred that the proportion of the polymer component A is larger than that of the polymer component B. This is because the polymer component A contains polyoxyalkyleneglycol and this polyoxyalkyleneglycol performs improvement in water-absorbing property of the wiping cloth made of nonwoven fabric. If the melting point of the polymer component B is established to be lower than that of the polymer component A by a certain degree and the splittable conjugate fibers are combined one another by heat bonding of the polymer component B, it is preferred that mass proportion of the polymer component A to the polymer component B is established as follows: polymer component A: polymer component B=70:30 to20:80. If the mass proportion of the polymer component B is less than 30 mass parts, the splittable conjugate fibers are not sufficiently combined one another, and it becomes difficult to obtain a wiping cloth of high tensile strength. On the other hand, if the mass proportion of the polymer component B is more than 80 mass parts, the splittable conjugate fibers are strongly heat bonded one another, and the heat-bonded areas are turned into a film-like condition or holes are formed. As a result, the obtained wiping cloth has a tendency to be insufficient in tensile strength.

The splittable conjugate fiber used in this invention can be either continuous fiber (filament) or discontinues fiber (for example, staple fiber). In general, it is preferred that the splittable conjugate fiber is continuous fiber. It is more rational to manufacture a wiping cloth made of nonwoven fabric by accumulating the continuous fibers as they are as compared with manufacturing a wiping cloth of nonwoven fabric after cutting the continuous fibers into discontinuous fibers. It is possible to use the splittable conjugate fiber of any fineness, however, the fineness is preferably in the range of 1 to 12 deniers. If the fineness of the splittable conjugate fiber is less than 1 denier, the fiber A and/or the fiber B produced by splitting tends to be less than 0.05 denier in fineness, and such fine fiber is prone to arise a problem of fiber breakage and occurrence of lint. On the other hand, if the fineness of the splittable conjugate fiber is more than 12 deniers, the fiber A and/or the fiber B a is so become large in fineness, and the performance of removing fine dust is prone to be lowered.

In the wiping cloth made of nonwoven fabric according to the invention, it is preferred that the fibers A and the fibers B are merely accumulated, however, it is more preferred that they are substantiality entangled with one another in three dimensions. This is because the three-dimensional entanglement increases tensile strength of the wiping cloth. This substantial three-dimensional entanglement does not mean three-dimensional combination formed by merely accumulating the fibers but means entanglement in which shows a certain improvement in tensile strength is achieved by means such as water needling or needle punching.

In the case of producing a wiping cloth made of nonwoven fabric provided with both heat-bonded areas and areas not heat bonded using the splittable conjugate fibers in which the melting point of the polymer component B is lower than the melting point of the polymer component A, it is preferred that the fibers A and the fibers B existing in the areas not heat bonded are not three-dimensionally entangled with each other. This is because, in this case, the splittable conjugate fibers are heat bonded with each other in the heat-bonded areas, thereby a sufficient great tensile strength is given to the wiping cloth. This is further because it is possible to give more softness or flexibility to the wiping cloth when the fibers A and the fibers B are not three-dimensionally entangled with each other.

In the wiping cloth made of nonwoven fabric provided with both the heat-bonded areas and the areas not heat bonded, it is possible for the heat-bonded areas to take any configuration. For example, it is preferred that the heat-bonded are as being circular, triangular, oval, T-shaped, #-shaped, rhombic, quadrilateral and so on are scattered all over the wiping cloth made of nonwoven fabric in the form of scattered dots. It is also preferred that belt-like heat-bonded areas be placed in the longitudinal direction or in the transverse direction of the wiping cloth made of nonwoven fabric. Furthermore, it is also preferred that lattice-shaped heat-bonded areas are arranged on the whole wiping cloth of nonwoven fabric. In the case that the heat-bonded areas are arranged in the form of scattered dots, each heat-bonded area has preferably an area in the range of about 0.1 to 3.0 mm². The total of the heat-bonded areas preferably occupies in the range of about 2 to 50% of the surface area of the wiping cloth of nonwoven fabric, and more preferably in the range of 4 to 20%. In the case of arranging belt-like or lattice-shaped heat-bonded, width of the belt-like lines or that of the lines forming the lattice is preferably in the range of about 0.1 to 5 mm, and it is preferred that the lines are spaced away from each other at an interval of approximately 1 to 10 mm. If the total of the heat-bonded areas is over the mentioned range, the total of the areas not heat bonded is reduced, and there is a tendency for the wiping cloth to be poor in dust-removing performance. In other words, dust is mainly removed by the fibers A and the fibers B existing in the areas not heat bonded, and therefore the dust-removing performance tends to be reduced as the areas not heat bonded become smaller. If the heat-bonded areas are smaller than the mentioned range, the wiping cloth of nonwoven fabric has a tendency of lowering its tensile strength.

A plasma treatment is applied to the exfoliated faces of the fibers A and the fibers B forming the wiping cloth according to the invention. Unevenness is formed or micro fibrils are produced on the exfoliated faces of the fibers A and the fibers B. Therefore, the exfoliated faces have larger surface areas as compared with not-exfoliated faces of the fibers A and the fibers B, and applying plasma treatment to the exfoliated faces greatly increases the water-absorbing property of the fibers A and the fibers B. In other words, a group containing oxygen such as carbonyl, carboxyl, hydroxy, or hydroperoxide introduced by the plasma treatment is introduced into three foliated surfaces of which surface area has been increased. Furthermore, in some cases, cracks are formed by the plasma treatment, thereby the water-absorbing property of the fibers A and the fibers B is largely improved. The plasma treatment is carried out by introducing an accumulated stuff composed by accumulation of the fibers A and the fibers B into a plasma reactor. Therefore if a plasma treatment is applied to the exfoliated faces of the fibers A and the fibers B, the not-exfoliated faces of the fibers A and the fibers B are also treated with the plasma treatment as a matter of course. The weight per square meter of the wiping cloth made of nonwoven fabric according to the invention, which can be freely decided, is approximately in the range of 10 to 200 g/m² in general.

A preferred method for manufacturing the wiping cloth made of nonwoven fabric according to the invention is hereinafter described. First, the mentioned splittable conjugate fibers are accumulated to form a nonwoven web. In the case that the splittable conjugate fibers are discontinuous fibers, any publicly known method such as card method or random webber method can be used to form the nonwoven web. In the case that the splittable conjugate fibers are continuous fibers or filaments, any publicly known method such as spunbond process can be used to form the nonwoven web. Described below is a method for obtaining a nonwover web by spunbond process. The polymer component A and the polymer component B are fed to a conjugate melt spinning apparatus, and discharged from a conjugate spinneret. Then, splittable conjugate continuous fibers (not drawn yet) each of which is formed by sticking the polymer component A and the polymer component B together are spun out. The spun out continuous fibers are cooled and introduced into an air sucker. The air sucker, which is also called an air jet in general, is used to carry continuous fibers and draw continuous fibers by sucking and sending air. The continuous fibers fed to the air sucker are conveyed to an out let of the air sucker while being drawn, and the continuous fibers are turned into splittable conjugate continuous fibers by completing the drawing. Then, an opening machine located at the outlet of the air sucker opens the splittable conjugate continuous fibers Any publicly known conventional method such as corona discharge or trio electrification is adopted for opening the fibers. The opened splittable conjugate continuous fibers are accumulated on a moving collection conveyor of wire mesh or the like, thus a nonwoven web is formed.

Next, a splitting treatment is applied to this nonwoven web. Since accumulating splittable conjugate fibers forms the nonwoven web, the fibers are not combined with each other and the tensile strength is extremely low. It is therefore necessary to combine or entangle the splittable conjugate fibers with each other in order to give a certain tensile strength to the nonwoven web, However, when adopting water needling or needle punching as the splitting treatment, it becomes possible to split and entangle the fibers at the same time, and therefore combining or entangling the splittable conjugate fibers with each other can be omitted. It is also possible to apply a partial temporary pressing to the nonwoven web in view of improving easiness in handling and transferring the nonwoven web at the time of applying the water needling or needle punching thereto. Generally in this temporary pressing, the splittable conjugate fibers are weakly heat bonded with each other, and water needling or needle punching easily loosens this heat-bonded state. Water needling is a treatment in which a pillar-shaped flow of liquid having a high kinetic energy is bumped on the nonwoven web, and the splittable conjugate fibers in the nonwoven web receive a shock of the pillar-shaped flow of liquid. Accordingly, the splittable conjugate fibers are split into the fibers A composed of the polymer component A and the fibers B composed of the polymer component B. Thus the kinetic energy of the pillar-shaped flow of liquid is applied to the fibers A and the fibers B, and the fibers are three-dimensionally entangled with each other. On the other hand needle punching is a treatment in which a needle pierces the nonwoven web many times. The needle bumps the splittable conjugate fibers, and consequently the splittable conjugate fibers are split into the fibers A and the fibers B, and the fibers are moved by the needle, thus the fibers are three-dimensionally entangled with each other.

In orders to give a certain tensile strength to the nonwoven web the splittable conjugate fibers are combined with each other in some cases. As a typical means for combining the splittable conjugate fibers with each other, heat-bonded areas are formed by heat bonding the splittable conjugate fibers together. In this case, by sticking together the polyester polymer component A having a high melting point and the polyolefin polymer component B having a low melting point form the splittable conjugate fibers. And at least a part of the polymer component B is exposed on the surface of the splittable conjugate fibers. Then the nonwoven web is introduced into an embossing apparatus comprised of a heated embossing roll and a flat roll or an embossing apparatus comprised of a pair of heated embossing rolls. Protruding part of the embossing roll is pressed on the nonwoven web (i.e., the nonwoven web is partially heated), whereby only the polymer component B of the splittable a conjugate fibers is softened or melted, and the splittable conjugate fibers come to be heat bonded with each other. Thus a nonwoven fleece having a certain tensile strength is obtained. In this nonwoven fleece, there are heat-bonded areas in which the splittable conjugate fibers are heat bonded with each other and areas not heat bonded in which the splittable conjugate fibers are not heat bonded with each other. In general, it is preferred that the embossing roll is heated at a temperature not higher than the melting point of the polymer component B in the splittable conjugate fiber. If the embossing roll is heated at a temperature higher than the melting point of the polymer component B, there is a possibility that the splittable conjugate fibers in the heat-bonded areas melt excessively and holes are formed on the heat-bonded areas. The end faces of the protruding part of the embossing roll can be of any form, that is the end faces can be oval, rhombic, triangular, T-shaped, #-shaped, or lattice-shaped so that the heat-bonded areas may be formed into any desired configuration. It is also preferred to use an ultrasonic bonding apparatus comprised of an uneven roll and an oscillator instead of the mentioned embossing apparatus as a matter of course.

Splitting is applied to the nonwoven fleece obtained by partially heating the nonwoven web. It is possible to use the mentioned water needling or needle punching as specific means of the splitting. In this case, the splittable conjugate fibers existing in the areas not heat be bonded are split into the fibers A composed of the polymer component A and the fibers B composed of the polymer component B. Then the fibers A and the fibers B are three-dimensionally entangled with each other by water needling or needle punching. It is also preferred to adopt means of carrying out crumpling treatment by applying a high-pressure jet to the nonwoven fleece. The high-pressure jet can be easily applied to the nonwoven fleece by putting the nonwoven fleece in a high-pressure jet-dyeing machine generally employed in dyeing. In this case, the splittable conjugate fibers are split into the fibers A and the fibers B by crumpling treatment and the split fibers A and B are entangled with each other to a certain degree. Such a entanglement is, however, a three-dimensional entanglement looser than that obtained by water needling or needle punching.

It is also preferred to adopt a buckling treatment as means of splitting. The buckling treatment is used to buckle the nonwoven fleece. More specifically, adopted is a method in which the nonwoven fleece is introduced into a pair of rolls at a speed higher than a discharging speed so that the nonwoven fleece introduced from the rolls may be buckled. As an apparatus for conducting such specific means, it is possible to use Microcreper manufactured by Micrex Co., COMFIT Machine manufactured by Uenoyama Kiko Co., Ltd., or the like. In the buckling treatment, the split fibers A and B are not substantially entangled with each other in three dimensions. This is because energy causing the fibers A and the fibers B to entangle with each other is not applied in the buckling treatment. Accordingly, the wiping cloth of nonwoven fabric obtained by the buckling treatment is soft, flexible and suitable for a wiping cloth because the fibers A and the fibers B existing in the areas not heat bonded are not substantially entangled with each other in three dimensions.

The splittable conjugate fibers are split into the fibers A and the fibers B, and fineness of either the fibers A or the fibers B is preferably in the range of about 0.05 to 1.5 denier. For example, if the splittable conjugate fibers having a transverse section as shown in FIG. 1 or FIG. 4 are used, fineness of the fibers A is preferably in the range of about 0.05 to 0.5 denier, and fineness of the fibers B is preferably in the range of about 1.0 to 2.0 deniers. If the splittable conjugate fibers having a transverse section as shown in FIG. 2 or FIG. 3 are used, fineness of both fibers A and fibers B is preferably in the range of about 0.05 to 1.5 denier in Split rate in splitting the splittable conjugate fibers is not always necessary to be 100%. Split rate of not less than about 50% is sufficient, and the split rate of not less than about 70% is more preferred. The split rate is measured in the following manner. That is some of the areas where sticking state of the splittable conjugate fibers is exfoliated (split) are sampled and observed using a scanning electron microscope. Percentage of portions where the polymer component A and the polymer component B are exfoliated is observed, and an average value of the percentages is obtained, thus the split rate being measured.

After splitting the splittable conjugate fibers in the nonwoven web or the nonwoven fleece, a plasma treatment is applied. The plasma treatment is a treatment carried out by exposing the nonwoven web or the nonwoven fleece into a substance in a plasma state. The plasma state is a state in which, by applying a high voltage to the inert gas or heating the inert gas at a high temperature, an inert gas is dissociated into negatively charged particles and positively charged particles or is excited. From the industrial point of view, it is preferred to adopt a low-temperature plasma treatment in which a high voltage is applied to an inert gas. In the application of a high voltage, it is prefer red to adopt spark discharge, corona discharge, glow discharge or the like, and among them it is most preferred to adopt glow discharge from the industrial point of view. The pressure of the inert gas in a vessel at the time of applying a high voltage is preferably not more than about 66.5 hPa, and more preferably in the range of 0.013 to 13.3 hPa. The time of the plasma treatment is preferably in the range of about 1 second to 5 minutes.

The inert gas used in the plasma treatment can be any gas on condition that the gas itself is not polymerized when high voltage is applied. In other words, it is possible to adopt any gas on condition that the gas is negatively and positively charged or excited and acts on the object to be treated (the nonwoven web or the nonwoven fleece) without polymerization of the gas itself. As is clearly understood from the foregoing description, the gas itself is not polymerized under high voltage, and therefore the gas is referred to as inert gas in this invention. Specific examples of the inert gas are argon, nitrogen, helium, oxygen, ammonia, air and so on. It is especially preferred to use argon as the inert gas in this invention This is because, when using argon as the inert gas, a group containing oxygen is introduced into the exfoliated faces of the fibers A and the fibers B and cracks or flaws are easily formed on the exfoliated faces, and the hydrophobic property of the wiping cloth of nonwoven fabric is largely improved. As the plasma treatment apparatus, a glow discharge apparatus is generally used (pages 180 to 182, Fundamentals and Application of High Polymer Surface (I) edited by Yoshito IKADA and published by Kagaku-Dojin Publishing Co., Ltd.).

By applying the plasma treatment as described above, surfaces of the split fibers A and B (both the exfoliated faces and the not-exfoliated faces) are modified, and the water-absorbing property is improved. As unevenness or micro fibrils are formed or produced on the surfaces of the exfoliated faces by splitting, surface area of the exfoliated faces is enlarged as compared with the not-exfoliated faces, and thus advantages brought about by the modification by the plasma treatment are remarkable. More specifically, this modification brings about such advantages that a group containing oxygen such as carbonyl, carboxyl, hydroxy or hydroperoxide is introduced into high polymers forming the fibers A and the fibers B or that cracks or flaws are formed on the surfaces of the fibers A and the fibers B. As a result of such modification, the water-absorbing property of the wiping cloth of nonwoven fabric formed by accumulating the fibers A and the fibers B is improved. The wiping cloth made of nonwoven fabric according to the invention is obtained through the application of the foregoing plasma treatment.

### BRIEF DESCRIPTION OF DRAWINGS

FIG. 1 shows an example of a transverse cross sect ion of a splittable conjugate fiber according to the present invention.

FIG. 2 shows another example of a transverse cross section of a splittable conjugate fiber according to The invention.

FIG. 3 shows a further example of a transverse cross section of a splittable conjugate fiber according to the invention.

FIG. 4 shows a still further example of a transverse cross section of a splittable conjugate fiber according to the invention.

In each drawing, reference character A indicates the polymer component A, and reference character B indicates the polymer component B.

### BEST MODE FOR CARRYING OUT THE INVENTION

The invention is hereinafter specifically described on the basis of preferred embodiments. Note that the wiping cloth made of nonwoven fabric according to the invention and the method for manufacturing the wiping cloth made of nonwoven fabric according to the invention are not limited to these preferred embodiments. Measurement and evaluation of each property or characteristic in each of the examples were carried out in the following manner.

[Melt Index of Polymer Component B]: This was measured at a temperature of 190° C. in conformity to the method described in ASTM-D-1238(E).

[Water-absorbing Property of Wiping Cloth Made of Nonwoven Fabric]: The measurement was carried out in conformity to JIS L 1096 A method (dropping water method).

[Deterioration with Time of Water-absorbing Property of Wiping Cloth Made of Nonwoven Fabric]: The wiping cloth made of nonwoven fabric was put under an atmosphere of 25° C., and the water-absorbing property (dropping water method) was measured every twenty day.

[Removability of Wiping Cloth Made of Nonwoven Fabric]: A liquid (water and alcohol) was dropped on a vinyl plate, lightly wiped with a wiping cloth made of nonwoven fabric of approximately 10 cm square, and removability was evaluated from the liquid left on the vinyl plate. The evaluation was a synthetic judgment of a test in which 0.5 cc of the liquid was dropped on the vinyl plate and another test in which 2.0 cc of the liquid was dropped on the vinyl plate. The removability was evaluated in the following four grades.

⊚: The liquid was scarcely left, ◯: The liquid was slightly left, Δ: The liquid was considerably left, ×: The liquid was almost left.

### COMPARATIVE EXAMPLE 1

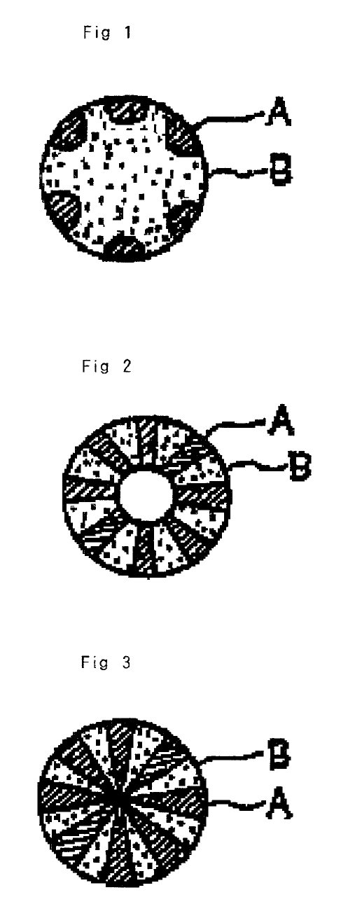

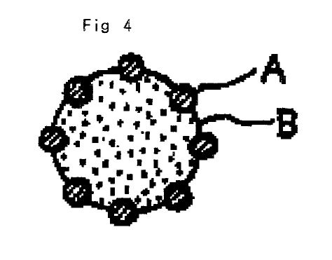

Polyethylene terephthalate containing 5 mass % polyethylene glycol of 6000 in mass average molecular weight was prepared as the polyester polymer component A. Melting point of This polyester polymer component A was 250° C. and relative viscosity was 1.49 at 20° C. when the polyester polymer component A was dissolved with a solvent prepared by mixing equivalent amounts of the orethane and phenol. On the other hand, high-density polyethylene, of which melting point was 127° C. and melt index was 20 g/10 min., was prepared as the polyolefin polymer component B. The polymer component A and the polymer component B were respectively melted and introduced into a conjugate spinneret. The adopted conjugate spinneret was provided with 210 conjugate spinning holes each being configured so that a splittable conjugate fiber having a transverse cross section as shown in FIG. 1 is obtained. A conjugate spinning machine in which the conjugate spinneret has four spindles was used in conjugate melt spinning. Conjugate spinning was carried out under the conditions that the emerging weight per hole is 1.3 g/min. and the conjugate ratio [the polymer component A/the polymer component B (proportion in mass) ] is 1.4/1 The temperature of the polymer was 285° C. for the polymer component A and 230° C. for the polymer component B, and the spinning temperature was 285° C.

Next, after cooling fi laments spun out of the conjugate spinneret with a cooling apparatus, these filaments were drawn out at 4000 m/min. by means of air suckers placed 150 cm below the spinneret. The splittable conjugate continuous fibers were opened with a publicly known opening machine and accumulated on the moving collection conveyor of wire mesh, and thus a nonwoven web was obtained. This nonwoven web was approximately 45 g in weight per square meter, and fineness of the splittable conjugate continuous fibers forming the nonwoven web was approximately 3 deniers. After that, this nonwoven web was introduced into an embossing apparatus comprised of an engraved roll (embossing roll) heated at 122° C. and the flat roll heated at 122° C., the heat-bonded areas were formed by partially applying a heat, thus a nonwoven fleece was obtained. The heat-bonded areas are areas in which the splittable conjugate continuous fibers are heat bonded one another due to softening or melting of the polymer component B. The areas to which heat was not applied are areas not heat bonded in which the splittable conjugate continuous fibers are not combined with one another but merely accumulated. Each heat-bonded area was 0.68 mm². total of the heat-bonded areas occupied 7.6% of the surface of the nonwoven fleece in terms of area, and density of the heat-bonded areas was 16.0 places/cm².

Next, the mentioned nonwoven fleece having heat-bonded a areas was fed to Microcreper I manufactured by Micrex Co. to apply the bucking treatment, the sticking of the polymer component A and the polymer component B in each of the splittable conjugate continuous fibers was exfoliated, and then the fibers A composed of the polymer component A and the fibers B composed of the polymer component B were revealed. The nonwoven fleece was fed to Microcreper I manufactured by Micrex Co. at 100 m/min. in working speed. In this manner, a nonwoven cloth was obtained, and in which the heat-bonded areas are scattered and the fibers A of approximately 0.3 denier in fineness and the fibers B of approximately 1.3 denier in fineness are revealed at least in the areas not heat bonded. Water-absorbing property, deterioration in water-absorbing property with time, and removability of this nonwoven fabric were then evaluated. Table 1 shows the results.

### COMPARATIVE EXAMPLE 2

Water needling was applied to the nonwoven web obtained in the foregoing Comparative Example 1, each of the splittable conjugate continuous fibers was split and the produced fibers A and B were three-dimensionally entangled with each other. The water needling was carried out under the following conditions. A pillar-shaped flow of high-pressure water (7.84 Mpa in pressure) was injected to the nonwoven web from a die comprised of three rows of injection holes, in which the holes are 0.12 mm in diameter, 600 in numbers and 0.6 mm in pitch. The nonwoven web was placed on a screen of 16 meshes, transferred at 10 m/min., and a distance between the injection holes and the nonwoven web was established to be 80 mm. After carrying out the water needling, the nonwoven web was mangled with a mangle roll and dried, thus a nonwoven fabric was obtained. In this nonwoven fabric, the fibers A of approximately 0.3 denier in fineness and the fibers B of approximately 1.3 denier in fineness were formed, and the fibers A and the fibers B were three-dimensionally entangled with each other. Water-absorbing property, deterioration in water-absorbing property with time, and the removability of this nonwoven fabric were respectively evaluated. Table 1 shows the results.

### COMPARATIVE EXAMPLE 3

Needle punching was applied to the nonwoven web obtained in the foregoing Comparative Example 1, each of the splittable conjugate continuous fibers were split, and the produced fibers A and B were three-dimensionally entangled with each other. The needle punching was carried out under the following conditions. RPD36# manufactured by Organ was employed as needle, and the needle punching was carried out at 60 times/cm² in needle punch density. In the obtained nonwoven fabric, the fibers A of approximately 0.3 denier in fineness and the fibers B of approximately 1.3 denier in fineness were formed, and the fibers A and the fibers B were three-dimensionally entangled with each. The water-absorbing property, deterioration in water-absorbing property with time, and the removability of this nonwoven fabric were respectively evaluated. Table 1 shows the results.

### COMPARATIVE EXAMPLE 4

A nonwoven fabric was obtained through the same method as that in the foregoing Comparative Example 2 except that polyethylene glycol is excluded from the polyester polymer component A used in Comparative Example 2. The water-absorbing property, deterioration in water-absorbing property with age, and the removability of this nonwoven fabric were respectively evaluated. Table 1 shows the results. As the result of excluding polyethylene glycol from the polyester polymer component A used in Comparative Example 2, the melting point of the polymer component A was 263° C. and the relative viscosity was 1.38.

### EXAMPLE 1

Low-temperature plasma treatment was applied to the nonwoven fabric obtained in the foregoing Comparative Example 1 under the following conditions, thus a wiping cloth made of nonwoven fabric was obtained. The water-absorbing property, deterioration in water-absorbing property with age, and the removability of this wiping cloth made of nonwoven fabric were respectively evaluated. Table 1 shows the results.

Conditions

| | |
|---|---|
| Treating apparatus: | Manufactured by Santo-tekko Co., Ltd. |
| Small-sized low-temperature | |
| plasma testing machine | |
| frequency: | 13.56 MHz |
| Electric power: | 200 W |
| Inert gas: | Argon (200 ml/min. in flow rate) |
| Treating time: | 30 seconds |
| Pressure of inert gas: | 1.33 hPa |

### EXAMPLE 2

Low-temperature plasma treatment was applied to the nonwoven fabric obtained in the foregoing Comparative Example 2 under the same conditions as that in the foregoing Example 1, thus a wiping cloth made of nonwoven fabric was obtained. The water-absorbing property, deterioration in water-absorbing property with time, and the removability of this wiping cloth made of nonwoven fabric were respectively evaluated. Table 1 shows the results.

### EXAMPLE 3

Low-temperature plasma treatment was applied to the nonwoven fabric obtained in the foregoing Comparative Example 3 under the same conditions as that in the foregoing Example 1. thus a wiping cloth made of nonwoven fabric was obtained. The water-absorbing property, deterioration in water-absorbing property with time, and the removability of this wiping cloth made of nonwoven fabric were respectively evaluated. Table 1 shows the results.

### EXAMPLE 4

A wiping cloth made of nonwoven fabric was obtained by the same method as that in the foregoing Example 2 except for using polyethylene terephthalate containing 10 mass percent polyethylene glycol of 6000 in mass average molecular weight as the polyester polymer component A. The water-absorbing property, deterioration in water-absorbing property with time, and the removability of this wiping cloth made of nonwoven fabric were respectively evaluated. Table 1 shows the results. The melting point of the polyester polymer component A used in this example was 248° C. and the relative viscosity was 164.

### EXAMPLE 5

A wiping cloth made of nonwoven fabric was obtained by the same method as that in the foregoing Example 2 except for using polyethylene terephthalate containing 1.0 mass percent polyethylene glycol of 6000 in mass average molecular weight as the polyester polymer component A. The water-absorbing property, deterioration in water-absorbing property with age, and the removability of this wiping cloth made of nonwoven fabric were respectively evaluated. Table 1 shows the results. The melting point of the polyester polymer component A used in this example was 260° C. and the relative viscosity was 1.40.

TABLE 1

| | Comparative | | | | | | | | |
|---|---|---|---|---|---|---|---|---|---|
| | Example | | | | Example | | | | |
| | 1 | 2 | 3 | 4 | 1 | 2 | 3 | 4 | 5 |
| Water-absorbing | 320 | 450 | 630 | 980 | 0.3 | 0.4 | 1.0 | 0.2 | 0.4 |
| Property (seconds) | | | | | | | | | |
| Deterioration in | | | | | | | | | |
| Water-absorbing | | | | | | | | | |
| Property | | | | | | | | | |
| with time | | | | | | | | | |
| Passed | | | | | | | | | |
| Days | | | | | | | | | |
| 0 | 340 | 450 | 630 | 980 | 0.3 | 0.4 | 1.0 | 0.2 | 0.4 |
| 20 | 380 | 500 | 620 | — | 0.8 | 1.1 | 1.4 | 0.3 | 29 |
| 40 | 350 | 580 | 660 | — | 1.2 | 1.8 | 2.0 | 0.8 | 45 |
| 60 | — | — | — | — | 1.8 | 2.6 | 3.0 | 1.2 | 68 |
| 80 | — | — | — | — | 3.3 | 3.2 | 3.8 | 2.5 | 70 |
| 160 | 380 | 520 | 620 | — | 4.3 | 3.7 | 4.5 | 3.0 | 75 |
| Removability | | | | | | | | | |
| Water | Δ | Δ | Δ | x | ⊚ | ⊚ | ⊚ | ⊚ | ∘ |
| Alcohol | Δ | Δ | Δ | x | ⊚ | ⊚ | ⊚ | ⊚ | ∘ |

Note:
“—” in Table 1 indicates that the water-absorbing property was not measured.

The results shown in Table 1 leads to the following conclusion. When comparing the foregoing Comparative Example 4 in which the polyester polymer component A not containing polyoxyalkyleneglycol was used with the foregoing Comparative Examples 1 to 3 in which the polyester polymer component A containing polyoxyalkyleneglycol was used, it is understood that the water-absorbing property is improved by approximately double due to the presence of polyoxyalkyleneglycol. On the other hand, in the foregoing Examples 1 to 5 in which the presence of polyoxyalkyleneglycol and the plasma treatment are combined or jointly used, the water-absorbing property is improved by at least about 1000 times as compared with Comparative Example 4. In other words, combination of polyoxyalkyleneglycol and the plasma treatment leads to a remarkably significant technical function and advantage.

When comparing the foregoing Example 5 in which the polyester polymer component A containing 1.0 mass percent polyoxyalkyleneglycol was used with the foregoing Examples 1 to 4 in which the polyester polymer component A containing 5 to 10 mass percent polyoxyalkyleneglycol was used, it is understood that deterioration in water-absorbing property with age is less in the latter case.

In the invention, when a polymer component containing polyoxyalkyleneglycol is used as the polymer component A forming the splittable conjugate fibers and splitting and plasma treatment are applied, it is possible to obtain the technical advantages of largely improving the water-absorbing property and decreasing deterioration in water-absorbing property with time.

What is claimed is:

1. a wiping cloth made of nonwoven fabric produced by using splittable conjugate fibers each of which is formed by sticking a polyester polymer component A containing polyoxyalkyleneglycol of 2000 to 20000 in mass average molecular weight and a polyolefin polymer component B which is insoluble in said polymer component A, accumulating fibers A composed of said polymer component A and fibers B composed of said polymer component B formed by exfoliating the sticking of the splittable conjugate fibers, and modifying exfoliated faces of said fibers A and said fibers B by plasma treatment.

2. A wiping cloth made of nonwoven fabric produced by using splittable conjugate fibers each of which is formed by sticking a polyester polymer component A containing polyoxyalkyleneglycol of 2000 to 20000 in mass average molecular weight and a polyolefin polymer component B which is insoluble in said polymer component A, and on each surface of which at least a part of said polymer component B is exposed, comprising heat-bonded areas and areas not heat bonded, wherein in said heat-bonded areas, said splittable conjugate fibers are accumulated and combined with each other by heat bonding of said polymer component B, and in said areas not heat bonded, fibers A composed of said polymer component A and fibers B composed of said polymer component B formed by exfoliating the sticking of the splittable conjugate fibers are accumulated, and exfoliated faces of said fibers A and said fibers B are modified by plasma treatment.

3. The wiping cloth made of nonwoven fabric according to claim 1 or claim 2, wherein a component containing 1.5 to 15 mass percent polyoxyalkyleneglycol of 2000 to 20000 in mass average molecular weight is used as the polyester polymer component A.

4. The wiping cloth made of nonwoven fabric according to claim 2 or claim 3, wherein the fibers A and the fibers B are not substantially entangled three-dimensionally with each other.

5. The wiping cloth made of nonwoven fabric according to any one of claims 1 to 3, wherein the fibers A and the fibers B are substantially entangled three-dimensionally with each other.

6. The wiping cloth made of nonwoven fabric according to any of claims 1 to 5, wherein the fibers A and the fibers B are continuous fibers.

7. A method for manufacturing a wiping cloth made of nonwoven fabric comprising the steps of: applying splitting to a nonwoven web produced by accumulating splittable conjugate fibers each of which is formed by sticking a polyester polymer component A containing polyoxyalkyleneglycol of 2000 to 20000 in mass average molecular weight and a polyolefin polymer component B which is insoluble in said polymer component A, thereby forming fibers A composed of said polymer component A and fibers B composed of said polymer component B; and modifying exfoliated faces of the fibers A and the fibers B by applying plasma treatment using an inert gas.

8. A method for manufacturing a wiping cloth made of nonwoven fabric comprising the steps of: forming a nonwoven web by accumulating splittable conjugate fibers each of which is formed by sticking a polyester polymer component A containing polyoxyalkyleneglycol of 2000 to 20000 in mass average molecular weight and a polyolefin polymer component B which is insoluble in said polymer component A and exposing at least a part of the polymer component B on the surface thereof; forming a nonwoven fleece by partly heating said nonwoven web to soften or melt said polymer component B thereby forming heat-bonded areas where said splittable conjugate fibers are heat bonded with each other and areas not heat bonded where said splittable conjugate fibers are not heat bonded with each other; applying splitting to said nonwoven fleece to exfoliate the sticking of said splittable conjugate fibers thereby forming fibers A composed of said polymer component A and fibers B composed of said polymer component B in said areas not heat bonded; and applying plasma treatment using an inert gas to modify exfoliated faces of the fibers A and the fibers B.

9. The method for manufacturing a wiping cloth made of nonwoven fabric according to claim 7 or 8, wherein a component containing 15 to 15 mass percent polyoxyalkyleneglycol of 2000 to 20000 in mass average molecular weight is used as the polyester polymer component A.

10. The method for manufacturing a wiping cloth made of nonwoven fabric according to claim 8 or 9, wherein the splitting is carried out by buckling treatment.

11. The method for manufacturing a wiping cloth made of nonwoven fabric according to any of claims 7 to 9, wherein water needling or needle punching carries out the splitting.

12. The method for manufacturing a wiping cloth made of nonwoven fabric according to any of claims 7 toll, wherein the splittable conjugate fibers are splittable conjugate continuous fibers.

13. The method for manufacturing a wiping cloth made of nonwoven fabric according to any of claims 7 to 12, wherein low-temperature plasma treatment is applied using argon as the inert gas.
